(19) United States
(12) Patent Application Publication
(10) Pub. No.: US 2026/0216867 A1
(43) Pub. Date: Jul. 30, 2026

(54) CONTROL SYSTEM, CONTROL DEVICE, AND CONTROL METHOD

(71) Applicant: HONDA MOTOR CO., LTD., Tokyo (JP)

(72) Inventor: Yuki Koyama, Wako-shi (JP)

(21) Appl. No.: 19/441,908

(22) Filed: Jan. 7, 2026

(30) Foreign Application Priority Data
Jan. 28, 2025 (JP) 2025-011868

(51) Int. Cl. B25J 9/16; B25J 15/10; B25J 17/00

(52) U.S. Cl. CPC B25J 9/1612; B25J 9/1653; B25J 15/10; B25J 17/00

(57) ABSTRACT

A control system for operating an end effector including a plurality of joints includes an acquisition unit configured to acquire data related to operation information, a determination unit configured to determine operation content from the data related to the operation information, a decision unit configured to decide a control method of the end effector in accordance with determination content, a calculation unit configured to perform joint angle optimization calculation including a decided priority level, and a command unit configured to transmit a joint angle to the end effector as an operation command. The decision unit has selection indices between control methods. Each selection index has a boundary between the control methods. A boundary width of each of the selection indices is normalized. A switching function obtained by plotting a value of each index using a distance of the boundary between the control methods in the normalized index is set.

### CROSS-REFERENCE TO RELATED APPLICATION

Priority is claimed on Japanese Patent Application No. 2025-011868, filed Jan. 28, 2025, the content of which is incorporated herein by reference.

### BACKGROUND OF THE INVENTION

### Field of the Invention

The present invention relates to a control system, a control device, and a control method.

### Description of Related Art

For example, several control methods have been proposed for a case where an action of a human hand is mapped to an action of a multi-fingered hand of a robot in a remote operation, but it is known that these control methods have advantages and disadvantages. For this reason, a hybrid method using separate control methods in accordance with a situation and task has been proposed (see, for example, the following Patent Document 1).

There are two points to be considered when the hybrid method is implemented. The two points are a control method to be used and a switching method for switching the control method between the control methods. In this regard, the following things have been proposed. The control method is, for example, a hybrid control method of joint-angle-based control and inter-fingertip-distance-based control. The switching method is based on a single criterion, such as an inter-fingertip distance. To switch the control method between these control methods, the control is switched to the inter-fingertip-distance-based control when the inter-fingertip distance is less than a set threshold.
[Patent Document 1] Japanese Unexamined Patent Application, First Publication No. 2023-131033

### SUMMARY OF THE INVENTION

However, in the conventional technology, there are two control methods between which the control method is switched and it is difficult to smoothly switch the control between two types of control because switching is based on a single index.

The present invention has been made in consideration of the above-described problems, and an objective of the present invention is to provide a control system, a control device, and a control method that can enable a control method to be smoothly switched to any one of a plurality of control methods.

To achieve this objective by solving the above-described problems, the present invention adopts the following aspects.

(1) According to an aspect of the present invention, there is provided a control system for operating an end effector including a plurality of joints, the control system including: an acquisition unit configured to acquire data related to operation information; a determination unit configured to determine operation content from the data related to the operation information; a decision unit configured to decide a control method of the end effector in accordance with determination content of the determination unit; a calculation unit configured to perform joint angle optimization calculation including a priority level decided by the decision unit; and a command unit configured to transmit a joint angle calculated by the calculation unit to the end effector as an operation command, wherein the decision unit has selection indices between two or more control methods, wherein each of the selection indices has a boundary between the two or more control methods, wherein a boundary width of each of the selection indices is normalized, and wherein a switching function obtained by plotting a value of each index using a distance of the boundary between the control methods in the normalized index is set.

Normalization is a process of adjusting the scale (units) of data so that different feature quantities (variables) can be compared, and is, for example, a process of processing data points so that they fall within a range of 0 to 1. Plotting is, for example, the arrangement of values (on a graph or the like).

(2) In the above-described aspect (1), the two or more control methods may be a method for performing control on the basis of a relative position calculated from a fingertip position and a method for performing control on a relative angle calculated from a hand joint angle, each of the selection indices may have a boundary for starting and ending switching of a corresponding relative position or angle, the boundary width of the selection index may be normalized, and a switching function obtained by plotting the value of each index using a distance of the boundary from the relative position or a distance of the boundary from the relative angle in the normalized index may be set.

(3) In the above-described aspect (1) or (2), the decision unit may smoothly switch the control method to another control method using the switching function when the control method is switched between the two or more control methods.

(4) In any one of the above-described aspects (1) to (3), the determination unit may extract the selection index required for identifying the control method from the data related to the operation information and determine a coefficient of each of the control methods on the basis of the extracted selection index, and the decision unit may decide the control method on the basis of a result of calculating a cost function using the coefficient of each of the control methods.

(5) In any one of the above-described aspects (1) to (3), a plurality of selection indices may differ according to each of the two or more control methods, the selection indices of a first control method may be an inter-fingertip distance, a direction of a normal vector of a nail, and a position of a thumb tip relative to a first joint of a paired finger, and indices of a second control method may be a distance between a finger side surface and the thumb tip, the normal vector of the nail, a position of a thumb relative to a tip of the paired finger in a wrist coordinate system, a position of the thumb relative to the tip of the paired finger in the wrist coordinate system being in an upward direction in the wrist coordinate system, and the position of the thumb tip relative to the first joint of the paired finger.

(6) In the above-described aspect (4), the coefficient may be set for each of a plurality of fingers and may be a value that continuously changes between 0 and 1.

(7) In any one of the above-described aspects (1) to (6), the end effector may be remotely operated by an operator in the control system, the acquisition unit may acquire operation information from the operator, and the determination unit may determine operation content of the operator from the operation information.

(8) In the above-described aspect (2), the end effector may be remotely operated by an operator in the control system, the relative position may be a position calculated from a position of a fingertip of the operator, and the relative angle may be an angle calculated from a joint angle of a hand of the operator.

(9) According to an aspect of the present invention, there is provided a control device for operating an end effector including a plurality of joints, the control device including: an acquisition unit configured to acquire data related to operation information; a determination unit configured to determine operation content from the data related to the operation information; a decision unit configured to decide a control method of the end effector in accordance with determination content of the determination unit; a calculation unit configured to perform joint angle optimization calculation including a priority level decided by the decision unit; and a command unit configured to transmit a joint angle calculated by the calculation unit to the end effector as an operation command, wherein the decision unit has selection indices between two or more control methods, wherein each of the selection indices has a boundary between the two or more control methods, wherein a boundary width of each of the selection indices is normalized, and wherein a switching function obtained by plotting a value of each index using a distance of the boundary between the control methods in the normalized index is set.

(10) According to an aspect of the present invention, there is provided a control method for operating an end effector including a plurality of joints, the control method including: acquiring, by an acquisition unit, data related to operation information; determining, by a determination unit, operation content from the data related to the operation information; deciding, by a decision unit, a control method of the end effector in accordance with determination content of the determination unit; performing, by a calculation unit, joint angle optimization calculation including a priority level decided by the decision unit; and transmitting, by a command unit, a joint angle calculated by the calculation unit to the end effector as an operation command, wherein the decision unit has selection indices between two or more control methods, wherein each of the selection indices has a boundary between the two or more control methods, wherein a boundary width of each of the selection indices is normalized, and wherein a switching function obtained by plotting a value of each index using a distance of the boundary between the control methods in the normalized index is set.

According to the above-described aspects (1) to (10), a control process can be performed by smoothly switching a control method to any one of a plurality of control methods.

### BRIEF DESCRIPTION OF THE DRAWINGS

FIG. 1 is an explanatory diagram of an overview of an embodiment.

FIG. 2 is a diagram showing an example of a configuration of a control system according to a first embodiment.

FIG. 3 is a sequence diagram of an overview of control mode decision according to the first embodiment.

FIG. 4 is a diagram showing an example of a decision procedure in step S3 of FIG. 3.

FIG. 5 shows an example of coefficients for each finger in a control mode according to the first embodiment.

FIG. 6 is a diagram showing an example of estimated values during a switching period.

FIG. 7 is an explanatory diagram of coefficient decision in a one-dimensional case.

FIG. 8 is a diagram showing an example in which an index value changes within three states when there are two indices.

FIG. 9 is a diagram showing an overlapping period between switching periods expressed by two switching ratios when the index value changes.

FIG. 10 is an explanatory diagram of coefficient decision in a two-dimensional case.

FIG. 11 is a flowchart of a process performed by the control device according to the first embodiment.

FIG. 12 is a diagram showing an example of evaluation results according to the first embodiment.

FIG. 13 shows an example of a state of a hand of an operator wearing an operation device and a state of an end effector operating on the basis of an instruction during evaluation.

FIG. 14 is an explanatory diagram of an implementation example of a case where a first control mode is based on a joint angle.

FIG. 15 is an explanatory diagram of an example of identification conditions when a second control mode is based on an inter-fingertip distance.

FIG. 16 is an explanatory diagram of an implementation example of a case where the second control mode is based on the inter-fingertip distance.

FIG. 17 is an explanatory diagram of an implementation example of a case where the third control mode is lateral pinching.

FIG. 18 is an explanatory diagram of an implementation example of a case where the third control mode is based on an inter-fingertip distance.

FIG. 19 is a diagram showing an example of a configuration of a control system according to a second embodiment.

FIG. 20 is a flowchart of a process performed by a control device according to the second embodiment.

### DETAILED DESCRIPTION OF THE INVENTION

Hereinafter, embodiments of the present invention will be described with reference to the drawings. Also, in the drawings used for the following description, the scales of respective members may have been appropriately changed to make each member have a recognizable size.

In all explanatory diagrams for the embodiments, the same reference signs are used for constituent elements with the same function, and redundant descriptions will be omitted.

Moreover, in the present specification, the term “on the basis of XX” means “based on at least XX” and also includes a case based on another vertex in addition to XX. Moreover, the term “on the basis of XX” is not limited to a case where XX is directly used and includes a case based on a result of performing a calculation operation or processing on XX. “XX” is any element (e.g., any information).

### Overview

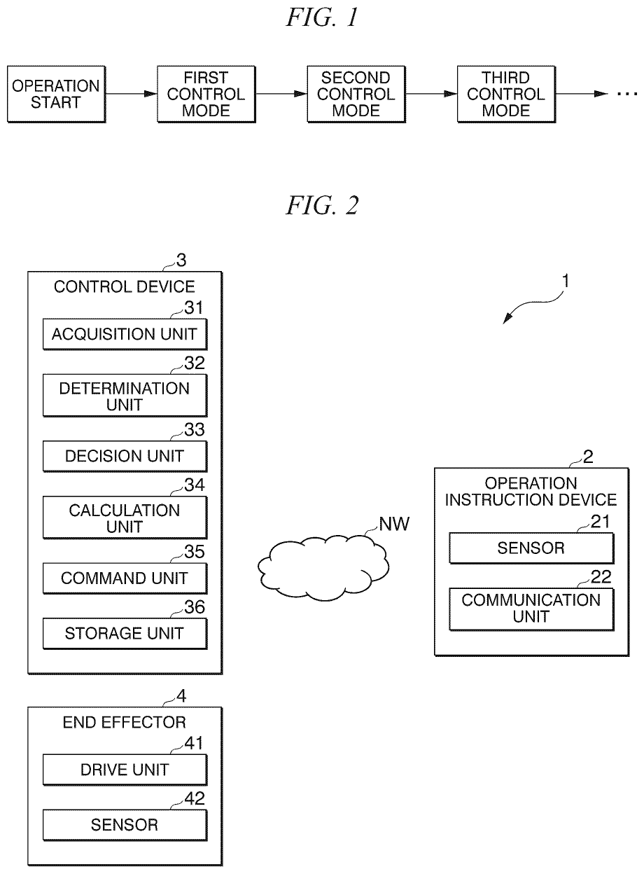

FIG. 1 is an explanatory diagram of an overview of an embodiment. In the example shown in FIG. 1, an end effector, for example, is remotely operated to perform a task. Control is first performed in a first control mode, subsequently performed in a second control mode, and subsequently performed in a third control mode. The first control mode is, for example, joint-angle-based control. The second control mode is, for example, inter-fingertip-distance-based control. The third control mode is, for example, control of lateral pinching. The lateral pinching (or lateral ping) is a pinching action when a thumb is positioned on a side surface of an index finger, and is an action when a book is held or a card or document is grasped. In this remote control, the operation mode to be controlled is switched on the basis of a joint angle, a distance between fingers at the time of a task instruction, and the like. In the present embodiment, one of a plurality of control modes is decided on the basis of a cost function on the basis of an index extracted from a control instruction having a plurality of indices (selection indices). A switching function is introduced to switch the control mode, and the control mode is smoothly switched.

The configuration and method of the embodiment are not limited to remote control, and can also be applied to automatic control in which control mode switching occurs during a task.

### First Embodiment

In the present embodiment, an example in which the end effector is remotely operated will be described.

FIG. 2 is a diagram showing an example of a configuration of a control system according to the present embodiment. As shown in FIG. 2, the control system 1 includes, for example, an operation instruction device 2, a control device 3, and an end effector 4.

The operation instruction device 2 includes, for example, a sensor 21 and a communication unit 22.

The control device 3 includes, for example, an acquisition unit 31, a determination unit 32, a decision unit 33, a calculation unit 34, a command unit 35, and a storage unit 36.

The end effector 4 includes, for example, a drive unit 41 and a sensor 42.

The operation instruction device 2 and the control device 3 are connected via a wired or wireless network NW. The control device 3 and the end effector 4 are connected via the wired or wireless network NW.

### [Operation Instruction Device]

The operation instruction device 2 is, for example, a data glove. An operator wears the operation instruction device 2 on his or her hand and remotely operates the end effector 4 to perform a task by moving his or her hand.

The sensor 21 detects, for example, a joint angle of each of the operator's fingers. The sensor 21 detects a position of each of the fingers of the operator.

The communication unit 22 outputs a detection value detected by the sensor 21 to the control device 3 at predetermined time intervals.

### [Control Device]

The acquisition unit 31 acquires the detection value output by the operation instruction device 2. That is, the acquisition unit 31 acquires operation information from the operator.

The determination unit 32 determines content of the operator's operation from the operation information.

The decision unit 33 decides a control method of the end effector 4 in accordance with the determination of the determination unit 32. The decision unit 33 smoothly switches a control mode to another control mode using a switching function, to be described below. The decision unit 33 has selection indices between two or more control methods. Each of the selection indices has a boundary between the two or more control methods. A boundary width of each of the selection indices is normalized. A switching function obtained by plotting a value of each index using a distance of the boundary between the control methods in the normalized index is set. “Plotting” refers, for example, to an arrangement of values (on a graph or the like).

The calculation unit 34 performs joint angle optimization calculation including a priority level decided by the decision unit 33.

The command unit 35 transmits a joint angle calculated by the calculation unit 34 to the end effector 4 as an operation command.

The storage unit 36 stores a threshold, a mathematical formula used for control, a control algorithm, and the like.

### [End Effector]

The end effector 4 includes, for example, a plurality of fingers. The end effector 4 may be attached to a body, may be both arms, or may include a leg part.

The drive unit 41 operates by an instruction from the control device 3 and is attached to each joint of a movable part of the end effector 4. The drive unit 41 includes, for example, an actuator, a drive circuit, and the like.

The sensor 42 is provided on each joint, the belly of the finger, and the like. The sensors 42 detect, for example, a position, an angle, and the like. The sensors 42 output the detected detection values to the control device 3.

[Acquisition of Information about Hand of Operator]

Information about the operator's hand and fingers may be acquired in advance and stored in the storage unit 36 or may be acquired for each task. The acquired information is a length of each joint of each finger and the like, and may be acquired using, for example, the method described in Patent Document 1.

### [Control Mode Decision Procedure]

Next, an example of a control mode decision procedure will be described. Although an example in which the number of control modes is three will be described in the following example, the number of control modes may be two, four, or more.

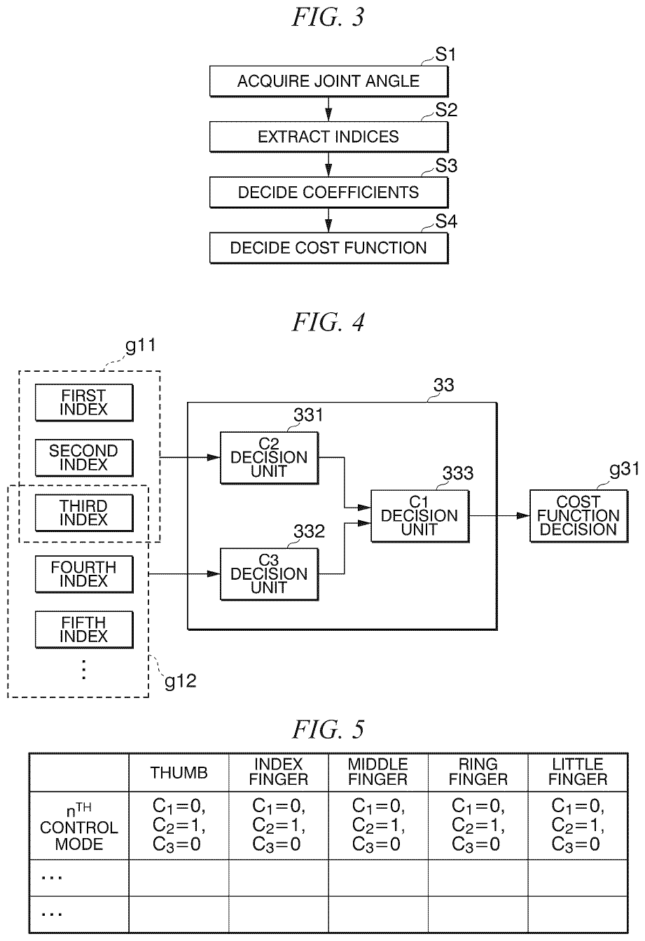

FIG. 3 is a sequence diagram of an overview of control mode decision according to the present embodiment.

(Step S1) The acquisition unit 31 acquires the operator's joint angle and fingertip posture from the operation instruction device 2.

(Step S2) The determination unit 32 extracts indices required for identification for each control mode. The indices include, for example, a position of a base of the thumb, a joint angle of a first joint of the thumb, a position of a base of the index finger, a joint angle of a first joint of the index finger, a joint angle of a second joint of the index finger, and the like.

(Step S3) The determination unit 32 decides coefficients on the basis of the extracted indices.

(Step S4) The decision unit 33 calculates a cost function to decide the control mode to be used and decide a switching timing.

FIG. 4 is a diagram showing an example of a decision procedure in step S3 of FIG. 3. In the following description, a first index is denoted by “m₁,” a second index is denoted by “m₂,” . . . , and an n^{th} index is denoted by “mₙ.”

C₁ is a coefficient related to selecting the first control mode. C₂ is a coefficient related to selecting the second control mode. C₃ is a coefficient related to selecting the third control mode. Each coefficient has a value between 0 and 1.

A C2 decision unit 331 acquires indices (e.g., m₁, m₂, and m₃, as in reference sign g11) to be used to decide the coefficient C₂. The C2 decision unit 331 decides the coefficient C₂ on the basis of the acquired indices.

A C3 decision unit 332 acquires indices to be used to decide the coefficient C₃ (e.g., m₃, m₄, and the like as in reference sign g13). The C3 decision unit 332 decides the coefficient C₃ on the basis of the acquired indices.

By selecting indices for the coefficients C₂ and C₃ so that the second control mode and the third control mode coexist independently, it is possible to set the coefficients C₂ and C₃ so that only one of the coefficients C₂ and C₃ is “1.”

A C1 decision unit 333 decides the coefficient C₁, for example, using C₁=1−(C₂+C₃).

Using this formula, when the control modes corresponding to the coefficients C₂ and C₃ are not used, control is basically performed using a term of the coefficient C₁. When the sum of the coefficients C₂ and C₃ exceeds 1, the C1 decision unit 333 corrects the value of the coefficient C₁ to 0.

The number of coefficients is a number according to the number of control modes. Therefore, when there are four control modes, the number of coefficients is four.

The coefficients C₁, C₂, and C₃ are decided for each finger, as shown in FIG. 5. FIG. 5 shows an example of coefficients for each finger in the control mode according to the present embodiment. As shown in FIG. 5, in the n^{th} control mode, for example, the coefficients for the thumb and index finger are (C₁=0, C₂=1, and C₃=0), and the coefficients for the middle finger, ring finger, and little finger are (C₁=1, C₂=0, and C₃=0). Because this control mode is an example of pinching, the coefficient for the index finger is set to C₂=1 to match the index finger. Because the other fingers are in basic control, C₁=1.

The decision unit 33 uses the decided coefficients to calculate u, which is one of the optimal end effector joint angles, using, for example, the cost function in the following formula (1).

$$u ∈ {arg min}_{{q}_{r}} {C}_{1} {f}_{ba} ( {q}_{r} ) + {C}_{2} {f}_{pi} ( {q}_{r} ) + {C}_{3} {f}_{la} ( {q}_{r} ) \qquad ( 1 )$$

In formula (1), f_{ba}(qᵣ) denotes a function for the basic control mode, fₚᵢ(qᵣ) denotes a function for the pinching control mode, fₗₐ(qᵣ) denotes a function for the lateral pinching control, and qᵣ denotes an angle of the operator's finger joint.

### [Index and Switching Ratio]

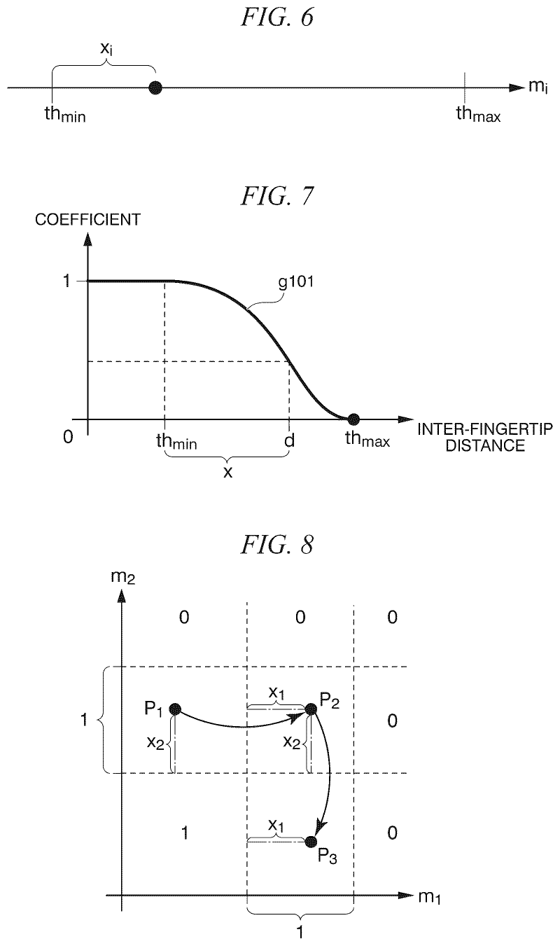

FIG. 6 is a diagram showing an example of estimation values for a switching period. The horizontal axis represents an index mᵢ. mᵢ denotes a feature quantity for weighting, and is expressed by the following formula (2). For example, m₁ denotes a distance between the tip of the thumb and the tip of the index finger.

$${m}_{i} ( {q}_{h} , {x}_{h} ) ∈ ℝ \qquad ( 2 )$$

A matrix Mₕ including feature quantities corresponding to the control modes is expressed using these feature quantities. For example, M₁=[m₁ m₂ m₃]^{T} (where T denotes transpose) and M₂=[m₄ m₅ m₆ m₇ m₈]^{T}.

In FIG. 6, thₘᵢₙ denotes a first threshold, and thₘₐₓ denotes a second threshold. These thresholds are set in advance for each control mode. xᵢ denotes a switching ratio. The reason for setting two thresholds is to provide a switching period for smooth switching between the control modes.

Next, the combined switching ratio x for each control mode will be further described.

In the one-dimensional (single index) case, Num(Mⱼ)=1 and xⱼ=xᵢ.

FIG. 7 is an explanatory diagram of coefficient decision in the one-dimensional case. The horizontal axis represents a fingertip spacing (cm), and the vertical axis represents coefficients, which are normalized values. In this example, it is assumed that an inter-fingertip distance d (line g101) varies between the first threshold thₘᵢₙ and the second threshold thₘₐₓ in a cosine function. Here, the switching ratio is expressed by the following formula (3) on the basis of the first threshold that is the smaller threshold. Normalization is a process for adjusting the scale (units) of data to enable the comparison of different feature quantities (variables), and, is for example, a process for processing data points so that they fall within the range of 0 to 1.

$${x}_{i} = \frac{{m}_{i} - {th}_{min}}{t {h}_{max} - {th}_{min}} \qquad ( 3 )$$

Here, for example, when the first threshold is 3 cm and the second threshold is 7 cm, the coefficient C₁ is expressed as shown in the following formula (4).

$${C}_{1} = \{ \begin{matrix}1 & ( d \leq 3 cm ) \\ \frac{1}{2} ( 1 + cos ( π x ) ) & ( 3 cm \leq d \leq 7 cm ) \\ 0 & ( d \geq 7 cm )\end{matrix} \qquad ( 4 )$$

Next, a case where there are two coefficients, i.e., a two-dimensional case, will be described.

In the two-dimensional case, Num(Mⱼ)=2. FIG. 8 is a diagram showing an example in which an index value changes within three states when there are two indices. The horizontal axis represents the first index m₁, and the vertical axis represents the second index m₂. FIG. 8 is a three-dimensional diagram in which the coefficient is in the upward direction of the paper surface. As shown in FIG. 8, a switching period is provided for each index, and each region corresponds to a case where the coefficient is 1 or 0. The index value changes from P₁ to P₂ and from P₂ to P₃ according to the hand posture. Each region enclosed by a chain line represents a switching period.

As shown in FIG. 8, when the index is 2, a region where two switching periods overlap can be created. Non-overlapping regions can be defined as in one-dimensional cases. However, because the value of the index changes in an overlapping region and crosses the switching period, it is necessary to ensure continuity.

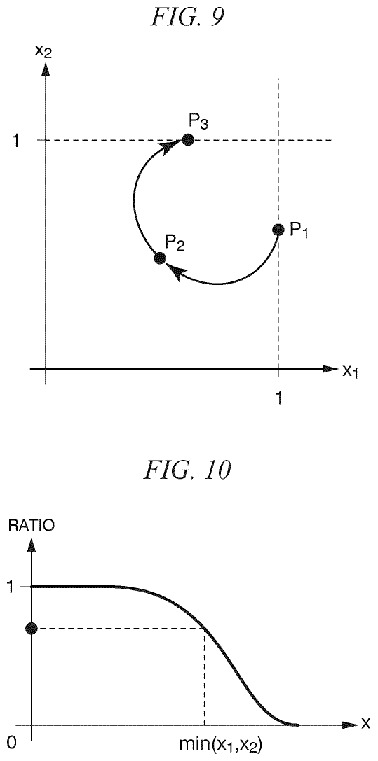

For this reason, in the present embodiment, in relation to a region where switching periods overlap, the switching ratios x₁ and x₂ can be reduced to a normalized square as shown in FIG. 9. FIG. 9 is a diagram showing an overlapping period between switching periods expressed by two switching ratios when the index value changes. The horizontal axis represents the first switching ratio x₁, and the vertical axis represents the second switching ratio x₂. Here, in the region where the switching periods overlap, the smaller of the two indices is adopted, as shown in the following formula (5). In this way, in the present embodiment, by selecting the smaller index, the switching ratio can be switched continuously.

$${x}_{j} = min ( {x}_{i} , {x}_{i - 1} ) \qquad ( 5 )$$

Furthermore, in the present embodiment, the coefficients can be smoothly decided on the basis of the adopted values using a cos function as shown in FIG. 10, as in the one-dimensional case described in FIG. 7. FIG. 10 is an explanatory diagram of coefficient decision in a two-dimensional case. In both the one-dimensional case and the two-dimensional case, the used function is not limited to a cos function, and it is only necessary to use any smoothly changing function.

Because switching occurs in a short period of time depending on the index (e.g., a switching period from 3 cm to 3.5 cm), the calculated ratio may be filtered (e.g., using a moving average filter) to slow a change speed.

While the one-dimensional case and the two-dimensional case have been described above, the above-described method can also be extended to three-dimensional cases (where the overlapping region is a cube), four-dimensional cases, . . . , n-dimensional cases.

### [Example of Processing Procedure]

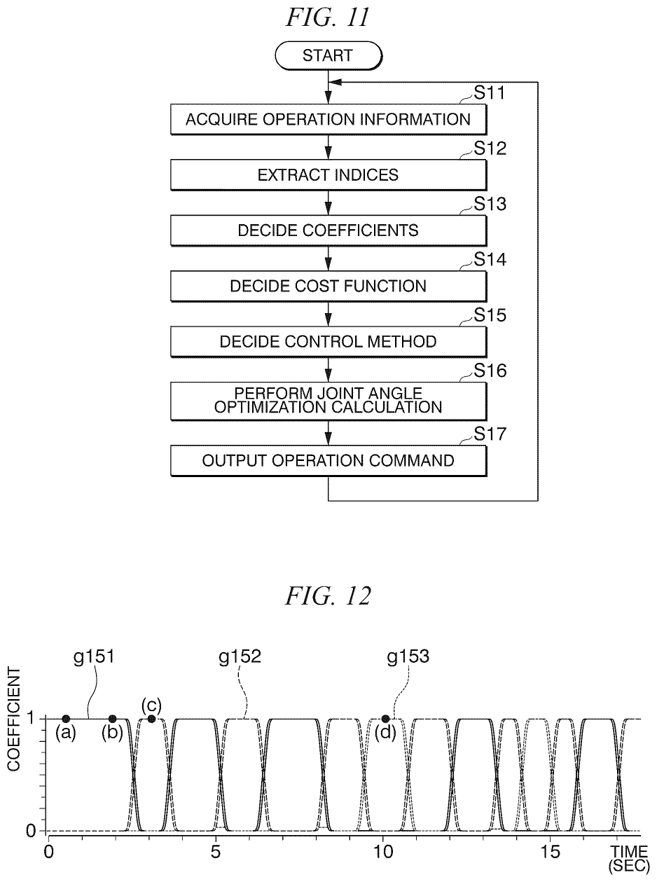

Next, an example of a processing procedure performed by the control device 3 will be described. FIG. 11 is a flowchart of a process performed by the control device according to the present embodiment.

(Step S11) The acquisition unit 31 acquires operation information about the operator (e.g., the operator's hand posture, joint angles, and the like).

(Step S12) The determination unit 32 extracts indices required for identification for each control mode.

(Step S13) The determination unit 32 determines coefficients on the basis of the extracted indices.

(Step S14) The decision unit 33 calculates a cost function.

(Step S15) The decision unit 33 decides a control mode to be used on the basis of the calculated cost function and decides a switching timing.

(Step S16) The calculation unit 34 performs joint angle optimization calculation including a priority level decided by the decision unit.

(Step S17) The command unit 35 transmits the joint angle calculated by the calculation unit 34 to the end effector 4 as an operation command, thereby controlling the action of the end effector 4.

The control device 3 iterates the above-described process at predetermined time intervals while the operator is giving instructions.

### [Example of Evaluation Results]

Next, an example of evaluation results when control is performed using the above-described configuration and method will be described.

FIG. 12 is a diagram showing an example of evaluation results according to the present embodiment. The evaluation results in FIG. 12 are an example of control performed by switching the control mode to any one of three control modes, and therefore, there are three coefficients (C₁ to C₃). The horizontal axis represents time (sec), and the vertical axis represents the normalized values of the coefficients C₁ to C₃. A line g151 indicates a change result of the coefficient C₁. A line g152 indicates a change result of the coefficient C₂. A line g153 indicates a change result of the coefficient C₃.

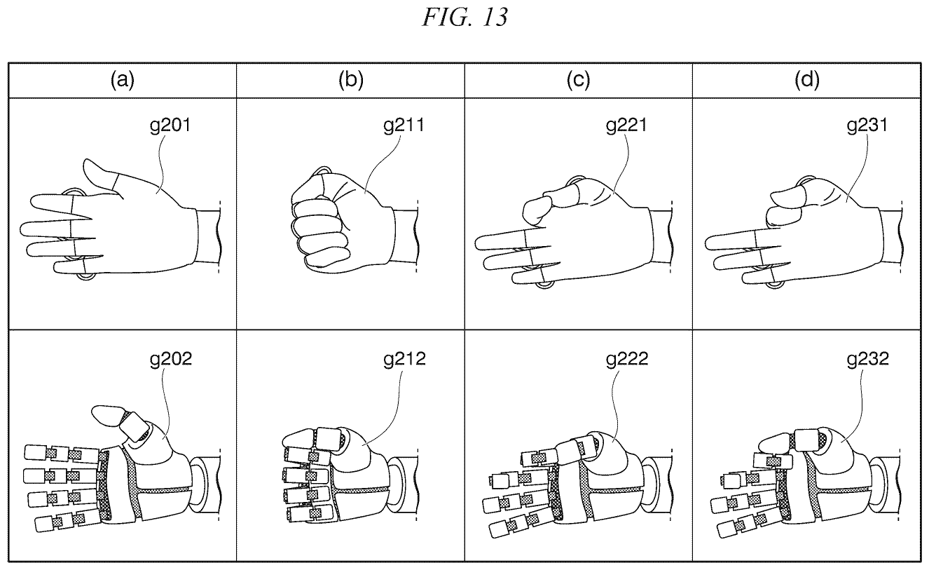

FIG. 13 shows an example of a state of a hand of the operator wearing the operating device and a state of the end effector operating on the basis of an instruction during evaluation.

When the time is approximately 0.5 sec in FIG. 12, the coefficient is C₁ and the state at a point (a) is a state of reference sign g201 (the state of the operator's hand) and reference sign g202 (the state of the end effector 4) in FIG. 13.

When the time is approximately 2 sec in FIG. 12, the coefficient is C₁ and the state at a point (b) is a state of reference sign g211 (the state of the operator's hand) and reference sign g212 (the state of the end effector 4) in FIG. 13.

When the time is approximately 3 sec in FIG. 12, the coefficient is C₂ and the state at a point (c) is a state of reference sign g221 (the state of the operator's hand) and reference sign g222 (the state of end effector 4) in FIG. 13.

When the time is approximately 10.2 sec in FIG. 12, the coefficient is C₃ and the state at a point (d) is a state of reference sign g231 (the state of the operator's hand) and reference sign g232 (the state of the end effector 4) in FIG. 13.

The control mode at the points (a) and (b) at the time of the coefficient C₁ is the joint-angle-based control mode. The control mode at the point (b) at the time of the coefficient C₂ is the inter-fingertip-distance-based control mode. The control mode at the point (c) at the time of the coefficient C₃ is the lateral pinching control mode.

As shown in FIGS. 12 and 13, as a result of verifying whether the switching process has been ideally performed by changing the hand posture, it has been confirmed that the control method has been switched as designed according to the operator's hand posture.

As described above, in the present embodiment, coefficients ranging from 0 to 1 are set for the plurality of control modes. In the present embodiment, each control mode is identified using an index extracted from a plurality of indices. In the present embodiment, the extracted index is used to create a framework for smooth coefficient switching. In the present embodiment, two thresholds are provided to set the switching period so that smooth switching is ensured. Also, in the present embodiment, a ratio (switching ratio) is used to indicate the location of the switching period on the basis of the smaller threshold. Furthermore, in the present embodiment, the smaller of the plurality of switching ratios is adopted in the region where the switching periods overlap. In the present embodiment, a smooth, continuous function, such as a cos function, is used for the adopted value.

Thereby, according to the present embodiment, it is possible to smoothly switch a control mode to any one of the plurality of control modes.

### First Example

Next, an implementation example of a case where the first control mode is based on a joint angle will be described.

FIG. 14 is an explanatory diagram of the implementation example of the case where the first control mode is based on the joint angle. In the first control mode, joint angles of the fingers other than the thumb are mapped as they are, as included in operation information (reference sign g202), and only the thumb is controlled on the basis of its fingertip position and the joint angles. The reason for this is that, in the end effector 4, only the thumb has a finger structure different from that of a human hand, and therefore, direct mapping does not allow appropriate control. The thumb is controlled at its relative position from the palm. However, to make the appearance of the thumb posture consistent, only the joint value of the second joint is mapped. The reason for this is to ensure that the shape of the thumb is aligned at the time of pinching.

### Second Example

Next, an implementation example of a case where the second control mode is based on an inter-fingertip distance will be described.

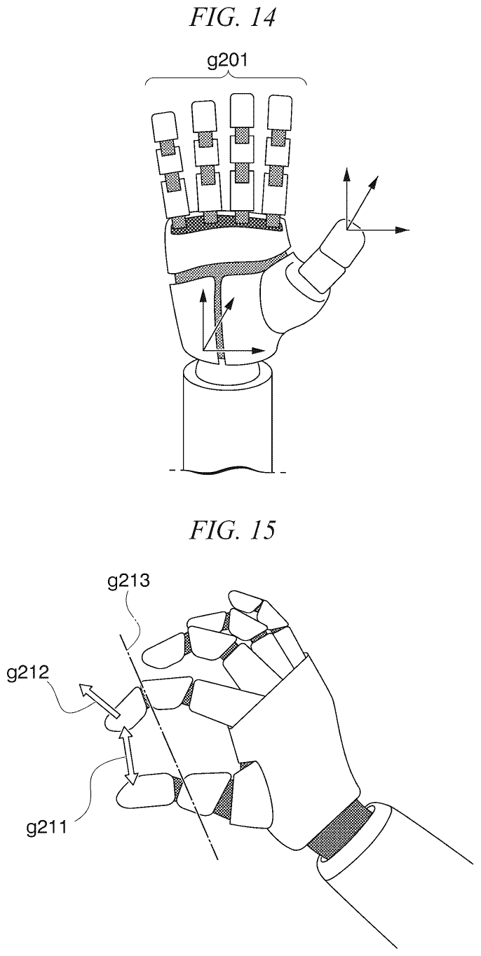

FIG. 15 is an explanatory diagram of an example of identification conditions of the case where the second control mode is based on the inter-fingertip distance. The following three indices are defined for the second control mode.

Condition I. Inter-Fingertip Distance (g211)

An inter-fingertip distance between the thumb and the finger performing the pinching. This index is added because the second control mode is primarily a control method for pinching.

Condition II. Direction of the Normal Vector of the Nail (g212)

This is added to distinguish between pinching and grasping actions according to a direction of the normal vector of the nail relative to the wrist coordinates. The direction of the normal vector of the nail is upward at the time of pinching and the direction of the normal vector of the nail is downward at the time of grasping.

Condition III. Position of the Thumb Tip Relative to the First Joint of the Paired Finger (g213)

A plane that slices through a first joint of the paired finger used for pinching is considered. The thumb is located on the fingertip side of this plane at the time of pinching and the thumb is located on the opposite side at the time of lateral pinching. This is added to distinguish between pinching and lateral pinching. Position information about the first joint has a positive or negative sign.

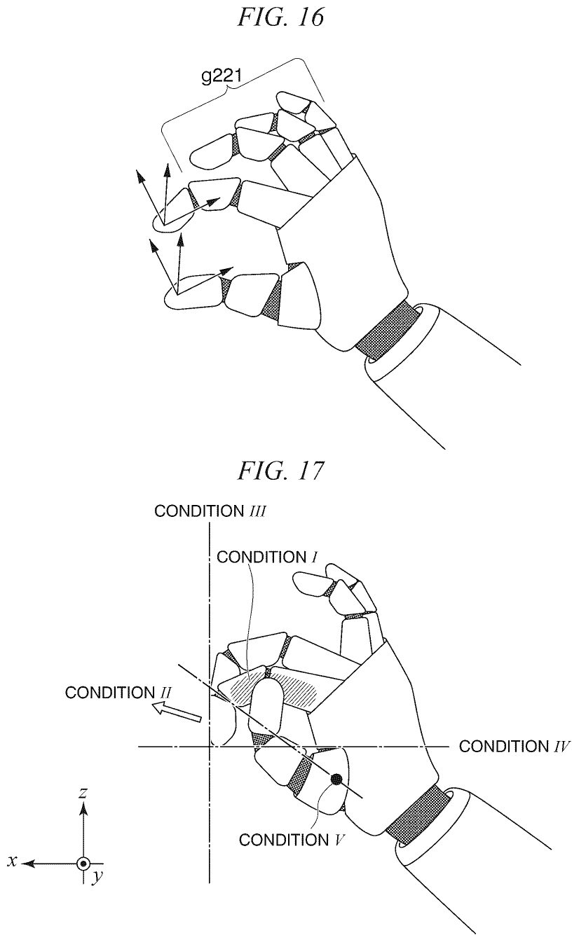

FIG. 16 is an exemplary diagram of an implementation example of a case where the second control mode is based on an inter-fingertip distance. As shown in FIG. 16, as the control method, a relative posture between fingertips of the thumb and the paired finger is controlled. In other words, control is performed to reproduce the operator's inter-fingertip posture. Fingers not used for pinching remain under basic control (g221). To achieve a natural pinching appearance, some joints are mapped to the operator's joint values. For example, the base of the index finger is controlled on the basis of the joint angle and the second joint of the thumb is controlled on the basis of the joint angle. In the end effector 4, the thumb has a first joint, a second joint, and a base to ensure natural thumb movement.

### Third Example

Next, an implementation example of a case where the third control mode is lateral pinching will be described.

FIG. 17 is an explanatory diagram of the implementation example of the case where the third control mode is the lateral pinching. In the third control mode, the following five indices are defined.

### Condition I: Distance Between the Side Surface of the Finger and the Tip of the Thumb

A position of the side surface of the finger is acquired in advance and switching is performed on the basis of the distance from the side surface. This is added because this control method is only used near the side surface.

### Condition II: Direction of the Normal Vector of the Nail

This is true for the second control mode. This is added to distinguish from a grasping action.

### Condition III: Position of the Thumb Relative to the Tip of the Paired Finger in the Wrist Coordinate System (Part 1)

The index for Condition V alone cannot distinguish between the states shown in FIG. 17. The reason is that the index for Condition V indicates a situation in which the tip of the thumb is closer to the base than the plane of the first joint of the paired finger, which is also valid when the hand is spread apart. Accordingly, to distinguish between the states, an index indicating that the thumb is located on the right (the −x direction) of the fingertip of the paired finger in the wrist coordinate system is added.

### Condition IV: Position of the Thumb Relative to the Tip of the Paired Finger in the Wrist Coordinate System (Part 2)

The reason is the same as for condition III. An index indicating that the thumb is above (+z direction) in the wrist coordinate system is added.

### Condition V: Position of the Thumb Tip Relative to the First Joint of the Paired Finger

This is true for the second control mode. This is added to distinguish from pinching

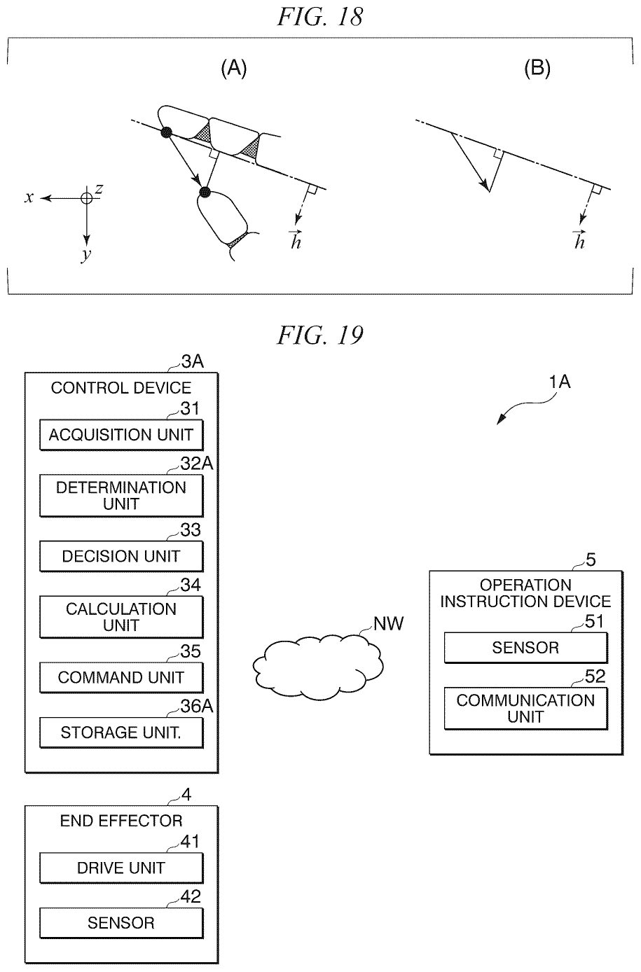

FIG. 18 is an explanatory diagram of an implementation example of a case where the third control mode is based on an inter-fingertip distance. Although a relative posture between fingertips of the thumb and the paired finger is controlled as the control method, the relative posture for mapping is corrected in consideration of a distance from a side surface of the paired finger.

FIG. 18 is a view from the +z direction in the wrist coordinate system, but it is known that the side surface of the finger is tilted relative to the wrist coordinates.

Therefore, the normal vector of that plane is acquired in advance, and mapping is performed by correcting a component in its direction (a component corresponding to a distance from the side surface).

The above-described examples and conditions are merely examples, and it is only necessary to set conditions in accordance with the task content, the structures of the hand and fingers of the end effector, and the like.

### Second Embodiment

Although an example in which the operator remotely controls the end effector 4 has been described in the first embodiment, a control device may automatically control the end effector 4.

In the following example, it is assumed that a target object is known and how the target object is placed is unknown.

FIG. 19 is a diagram showing an example of a configuration of a control system according to the present embodiment. As shown in FIG. 19, a control system 1A includes, for example, a control device 3A, an end effector 4, and an environmental sensor 5.

The control device 3A includes, for example, an acquisition unit 31A, a determination unit 32A, a decision unit 33, a calculation unit 34, a command unit 35, and a storage unit 36A.

The end effector 4 includes, for example, a drive unit 41 and a sensor 42.

The environmental sensor 5 includes, for example, a sensor 51 and a communication unit 52.

### [Environmental Sensor]

The environmental sensor 5 is installed, for example, within a range where it is possible to image physical objects and the end effector 4. The number of environmental sensors 5 may be two or more. The environmental sensor 5 may be attached to the palm, fingertips, and the like of the end effector 4.

The sensor 51 is, for example, an RGB-D (red/green/blue-depth) imaging device capable of measuring depth information D, a distance sensor, or the like.

The communication unit 52 outputs data detected by the sensor 51 to the control device 3A via the network NW.

### [Control Device]

The acquisition unit 31A acquires detection data output by the environmental sensor 5. In the present embodiment, the information acquired by the acquisition unit 31A is data related to operation information.

The determination unit 32A estimates what is a target part using the data acquired by the acquisition unit 31. This estimation is performed, for example, by pattern matching using the acquired image or by inputting data to a trained model. The determination unit 32A determines content of an operation to be performed on a target object. For example, the determination unit 32A inputs data into a trained model to estimate content of the operation to be performed on the target object (grasping, pinching, lifting, holding, or the like). The determination unit 32A extracts an index required for identification for each control mode. The determination unit 32A decides a coefficient on the basis of the extracted index.

The decision unit 33 decides a control method for the end effector 4 in accordance with the determination of the determination unit 32A. The decision unit 33 smoothly switches the control mode to another control mode using a switching function.

The calculation unit 34 performs joint angle optimization calculation including a priority level decided by the decision unit 33.

The command unit 35 transmits a joint angle calculated by the calculation unit 34 to the end effector 4 as an operation command.

The storage unit 36A stores a threshold, a mathematical formula used for control, a control algorithm, a trained model used by the determination unit 32A, or the like. The trained model may be stored in an externally connected server or the like or placed on the cloud.

The operation content, for example, may change after grasping. For example, the operation content may involve grasping a target object, then moving the target object while still grasping the target object, fitting it into another target object, or the like.

In the present embodiment, even if the end effector 4 is made to perform a task on, for example, an unknown target object, the target object and the operation content can be estimated, and the end effector can perform the task by switching the control method to any one of a plurality of control methods in accordance with the task content, as in the first embodiment.

### [Example of Processing Procedure]

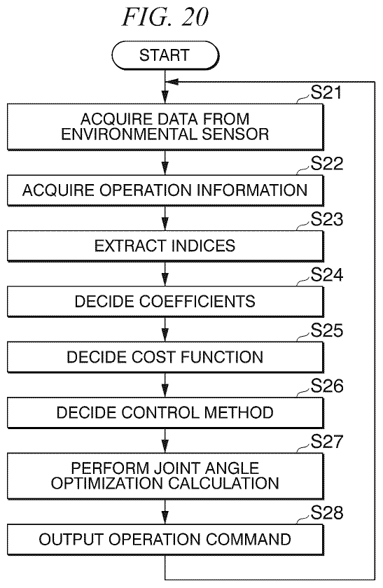

Next, an example of a processing procedure performed by the control device 3 will be described. FIG. 20 is a flowchart of a process performed by the control device according to the present embodiment.

(Step S21) The acquisition unit 31A acquires detection data output by the environmental sensor 5.

(Step S22) The determination unit 32A estimates what is the target object using the data acquired by the acquisition unit 31. Subsequently, the determination unit 32A determines content of the operation to be performed on the target object.

(Step S23) The determination unit 32A extracts indices required for identification for each control mode.

(Step S24) The determination unit 32A determines coefficients on the basis of the extracted indices.

(Step S25) The decision unit 33 calculates a cost function.

(Step S26) The decision unit 33 decides a control mode to be used and a timing for switching on the basis of the calculated cost function.

(Step S27) The calculation unit 34 performs joint angle optimization calculation including a priority level decided by the decision unit.

(Step S28) The command unit 35 transmits a joint angle calculated by the calculation unit 34 to the end effector 4 as an operation command, thereby controlling the action of the end effector 4.

The control device 3 iterates the above-described process at predetermined time intervals while the operator is giving instructions.

The configuration shown in FIG. 19 and the processing procedures and content shown in FIG. 20 are merely examples and the present invention is not limited thereto.

A program for implementing all or some functions of the control device 3 (or 3A) in the present invention is recorded on a computer-readable recording medium, and the program recorded on the recording medium is read into a computer system and executed, such that all or some processing steps of the control device 3 (or 3A) may be performed. The “computer system” used here is assumed to include an operating system (OS) or hardware such as peripheral devices. The “computer system” is also assumed to include a WWW system equipped with a homepage provision environment (or display environment). The “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory (random-access memory (RAM)) inside a computer system serving as a server or a client when the program is transmitted via a network such as the Internet or a communication circuit such as a telephone circuit.

Alternatively, some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation.

The above-described program may be transmitted from a computer system storing the program in a storage device or the like to another computer system via a transmission medium or by transmission waves in a transmission medium. Here, the “transmission medium” for transmitting the program refers to a medium having a function of transmitting information, as in a network (communication network) such as the Internet or a communication circuit (communication line) such as a telephone circuit. Also, the above-described program may be a program for implementing some of the above-described functions. Furthermore, the above-described program may be a so-called differential file (differential program) capable of implementing the above-described function in combination with a program already recorded on the computer system.

Although modes for carrying out the present invention have been described above using embodiments, the present invention is not limited to the embodiments and various modifications and substitutions can also be made without departing from the scope and spirit of the present invention.

What is claimed is:

1. A control system for operating an end effector including a plurality of joints, the control system comprising:
an acquisition unit configured to acquire data related to operation information;
a determination unit configured to determine operation content from the data related to the operation information;
a decision unit configured to decide a control method of the end effector in accordance with determination content of the determination unit;
a calculation unit configured to perform joint angle optimization calculation including a priority level decided by the decision unit; and
a command unit configured to transmit a joint angle calculated by the calculation unit to the end effector as an operation command,
wherein the decision unit has selection indices between two or more control methods,
wherein each of the selection indices has a boundary between the two or more control methods,
wherein a boundary width of each of the selection indices is normalized, and
wherein a switching function obtained by plotting a value of each index using a distance of the boundary between the control methods in the normalized index is set.

2. The control system according to claim 1,
wherein the two or more control methods are a method for performing control on the basis of a relative position calculated from a fingertip position and a method for performing control on a relative angle calculated from a hand joint angle,
wherein each of the selection indices has a boundary for starting and ending switching of a corresponding relative position or angle,
wherein the boundary width of the selection index is normalized, and
wherein a switching function obtained by plotting the value of each index using a distance of the boundary from the relative position or a distance of the boundary from the relative angle in the normalized index is set.

3. The control system according to claim 1, wherein the decision unit smoothly switches the control method to another control method using the switching function when the control method is switched between the two or more control methods.

4. The control system according to claim 1,
wherein the determination unit extracts the selection index required for identifying the control method from the data related to the operation information and determines a coefficient of each of the control methods on the basis of the extracted selection index, and
wherein the decision unit decides the control method on the basis of a result of calculating a cost function using the coefficient of each of the control methods.

5. The control system according to claim 1,
wherein a plurality of selection indices differ according to each of the two or more control methods,
wherein the selection indices of a first control method are an inter-fingertip distance, a direction of a normal vector of a nail, and a position of a thumb tip relative to a first joint of a paired finger, and
wherein indices of a second control method are a distance between a finger side surface and the thumb tip, the normal vector of the nail, a position of a thumb relative to a tip of the paired finger in a wrist coordinate system, a position of the thumb relative to the tip of the paired finger in the wrist coordinate system being in an upward direction in the wrist coordinate system, and the position of the thumb tip relative to the first joint of the paired finger.

6. The control system according to claim 4, wherein the coefficient is set for each of a plurality of fingers and is a value that continuously changes between 0 and 1.

7. The control system according to claim 1,
wherein the end effector is remotely operated by an operator in the control system,
wherein the acquisition unit acquires operation information from the operator, and
wherein the determination unit determines operation content of the operator from the operation information.

8. The control system according to claim 2,
wherein the end effector is remotely operated by an operator in the control system,
wherein the relative position is a position calculated from a position of a fingertip of the operator, and
wherein the relative angle is an angle calculated from a joint angle of a hand of the operator.

9. A control device for operating an end effector including a plurality of joints, the control device comprising:
an acquisition unit configured to acquire data related to operation information;
a determination unit configured to determine operation content from the data related to the operation information;
a decision unit configured to decide a control method of the end effector in accordance with determination content of the determination unit;
a calculation unit configured to perform joint angle optimization calculation including a priority level decided by the decision unit; and
a command unit configured to transmit a joint angle calculated by the calculation unit to the end effector as an operation command,
wherein the decision unit has selection indices between two or more control methods,
wherein each of the selection indices has a boundary between the two or more control methods,
wherein a boundary width of each of the selection indices is normalized, and
wherein a switching function obtained by plotting a value of each index using a distance of the boundary between the control methods in the normalized index is set.

10. A control method for operating an end effector including a plurality of joints, the control method comprising:
acquiring, by an acquisition unit, data related to operation information;
determining, by a determination unit, operation content from the data related to the operation information;
deciding, by a decision unit, a control method of the end effector in accordance with determination content of the determination unit;
performing, by a calculation unit, joint angle optimization calculation including a priority level decided by the decision unit; and
transmitting, by a command unit, a joint angle calculated by the calculation unit to the end effector as an operation command,
wherein the decision unit has selection indices between two or more control methods,
wherein each of the selection indices has a boundary between the two or more control methods,
wherein a boundary width of each of the selection indices is normalized, and
wherein a switching function obtained by plotting a value of each index using a distance of the boundary between the control methods in the normalized index is set.
